(19) United States
(12) Patent Application Publication
(10) Pub. No.: US 2013/0085807 A1
(43) Pub. Date: Apr. 4, 2013

(54) ONLINE SHOPPING

(71) Applicant: Deborah Anne Cincotta, Los Angeles, CA (US)

(72) Inventor: Deborah Anne Cincotta, Los Angeles, CA (US)

(21) Appl. No.: 13/645,111

(22) Filed: Oct. 4, 2012

Related U.S. Application Data
(60) Provisional application No. 61/542,946, filed on Oct. 4, 2011.

(51) Int. Cl. G06Q 30/02

(52) U.S. Cl. CPC G06Q 30/0203
USPC 705/7.32

(57) ABSTRACT

Online shopping may be facilitated by the use of an intermediate computer system a) collecting data from online shopping interactions, b) obtaining additional online shopping preference information related to a specific, potential online shopping transaction, c) forwarding a request a merchant based on the preference information to modify terms and/or conditions of the potential online transaction, and d) providing at least some of the related shopper's collected data for use by the one or more merchants considering the request. The transaction whereby the transaction may be completed in accordance with said request upon agreement between the related shopper and said one or more merchants.

### RELATED APPLICATIONS

This application claims the priority of the filing date of U.S. Provisional application Ser. No. 61/542,946, filed Oct. 4, 2011, entitled “e-Shopping Cart Coupon System” which is incorporated herein by the reference for all purposes.

### BACKGROUND OF THE INVENTION

1. Field of the Invention

This invention is related to online shopping such as shopping over the Internet and in particular to techniques for enhancing and facilitating the shopping experience for the shopper, consumer or other user by, for example, enhancing the use of coupons, discounts, shipping and quantity specials and similar promotions and sale incentives.

2. Description of the Prior Art

Various online shopping sites exist such as Amazon.com. In such conventional sites, a shopping cart or other display is provided so that the shopper can review the proposed items and services to be purchased and take advantage of various sales incentives such as promotion codes. The shopping or checkout cart often mimics physical shopping carts available in physical stores.

In many online shopping sites, products, including services, from a single merchant are offered for sale, providing the consumer with the experience of shopping at a merchant's outlet, such as Apple, in which the products for sale are typically Apple branded products. In many other online shopping sites, the products from a variety of merchants are offered for sale, providing the consumer with the experience of shopping in a department store in which products are offered from a variety of merchants selected by the department store or online shopping site.

Amazon.com, for example, provides an improved system by providing products offered for sale providing the consumer with categories of products to select from, two of which may be “Electronics” and “Computers”. As a result, the consumer is often able to find a particular product in more than one category of goods. That is, the consumer can search for a product such “cable” by searching in all of Amazon.com, in the Electronics section of Amazon.com or in the computer section of Amazon.com. If, as an example, the consumer was looking for a particular type of computer cable, but didn't know the name of the product, searching within the computer section of Amazon.com.

A further improvement currently offered by Amazon.com is to provide consumers with access to products offered by other sellers so that a consumer can select between a product offered by Amazon.com and the same or a similar product of the same brand (or even an alternate brand) offered by a different seller. One advantage to the consumer of this approach is that the consumer can select to purchase from a merchant not familiar to the consumer and yet substantially rely on the goodwill of Amazon.com who stands behind the merchant's sale of the product to the consumer.

Another aspect of online shopping is that many such sites offer the online shopper the opportunity, typically within the electronic shopping cart, to make various selections about the transaction. Such shopper selections may include method of payment, method of shipment as well as reducing the cost of the goods by use of a coupon or other sales incentive which typically may be accomplished by entering a number often called a promotion code.

As a result of the opportunity to use promotion codes in online shopping, various techniques have been made available for the online shopper to obtain promotion codes from other sources. Online vendors or merchants use promotions or coupons to attract shoppers to their sites, so the online merchant is not motivated to make the promotion codes first known to the online shopper when viewing the shopping cart because the value of the promotion codes to the merchant would be lost. Typically, an online shopper will select a product, or at least a merchant for such products, search for and find a promotion code useful in buying that product from that merchant, and enter the promotion code in the appropriate location in the online shopping cart or otherwise during checkout. The order in which these steps occur may vary, but the merchant's goal in offering the promotion is to drive traffic to the merchant's site rather than offer a general discount during checkout whether or not the promotion brought the shopper to the site.

Online shopping has become a major worldwide method of selling goods so that even minor changes which make the shopper more likely to buy may be extraordinarily important to merchants. Although many attempts, some successful, have been made to improve the online shopping experience, much remains to be done. Some of currently notable limitations of online shopping include the difficulty in finding products because searches for specific products often provide undesirable search results including discussions or reviews, price comparisons, a multiplicity of merchants. Although such details are often helpful, sophisticated shoppers recognize that merchants pay for higher positions in search results and much of the data obtained by such searching is at best questionable.

What are needed are techniques for improving, and facilitating the online shopping experience, so that shoppers are made as comfortable as possible in an intuitive way while feeling confident they are dealing with reliable merchants and are getting a good if not the best possible deal while shopping online.

### SUMMARY OF THE DISCLOSURE

A method of facilitating online shopping is disclosed in which an intermediate or third party computer is used to collect data from online shopping interactions of online shoppers. The computer also obtains additional online shopping preference information from shoppers related to a specific, potential online shopping transaction and forwards requests to merchants based on the preference information to modify terms and/or conditions of the potential online transaction.

The intermediary computer may act as an honest broker and thereby trusted by both the shopper and the merchant.

At least some of the related shopper's collected data is provided for use by the merchant considering the request and the transaction can be completed in accordance with said request upon agreement between the related shopper and merchant.

The reply may be provided by the merchant directly to the shopper as part of the potential transaction to consummate that transaction on acceptance by the shopper. The response may be forwarded the shopper with a link enabling completion of the potential transaction upon acceptance. Multiple response may be received and forwarded so that the related shopper may select a particular one of said plurality of responses.

Software plug-ins may be provided for downloading by shoppers so that data from online shopping interactions of said each of the plurality of online shoppers is automatically collected. Data from online shopping interactions may also be received from merchants.

Access for online shoppers to multiple merchants may be provided by a website display of a “virtual mall” including a large plurality of merchants selectable by merchant icons. The virtual mall may be modified by shoppers in accordance with their merchant preferences. Related pending responses may be displayed by modifying an appearance of a related merchant icon. Pending requests may also be displayed by modifying a merchant icon.

Publically known or available promotional codes may also be made accessible to shoppers. Further, adding at least portions of the online shopping preference information, requests and/or merchant responses and resultant completed transactions may be added to the data. At least portions of the collected data may be made available for analysis without disclosing personal identities of the shoppers.

### BRIEF DESCRIPTION OF THE DRAWINGS

FIG. 1 illustrates an overview of EOS system 10 implementing the improved online shopping techniques.

FIG. 2 is a computer display of virtual mall(s) 28 allowing shopper 12 to select one or more of a plurality of merchants 14 from various personalizable displays of merchants 14.

FIG. 3 is an exemplar of shopping cart 42.

FIG. 4 is an illustration of the interaction between shopper 12, merchant 14-1 and EOS computer system 20 during a transaction with a specific cart 41 and various public and non-public promotions that may be selectable on cart 42.

FIG. 5 is an illustration of interactions that a occur in the illustration shown in FIG. 5.

FIG. 6 is an illustration of the collection of merchant or company source data.

FIG. 7 is a flowchart for providing merchant icon information 14-x for each merchant displayed on at least one of the virtual mall(s) 28.

FIG. 8 is a flow chart of a presently preferred proves the presentation of the various merchant icons 14-1 for merchants displayed on at least one of the virtual mall(s) 28.

Referring now to FIG. 9, application flow for a general brokering scenario is illustrated.

Referring now to FIG. 10, application flow for a user initiated brokering system is illustrated.

Referring now to FIG. 11, an illustration is provided of a User-merchant Brokering system for a saved product, e.g., using a wish list.

Referring now to FIG. 12, an exemplar transaction is illustrated for an online shopping transaction in which shopper 12 has requested or at least indicated a preference for free shipping which is analyzed by intermediate computer 20, using data in databases 22, 23 and 24 and forward a request to merchant 14.

### DETAILED DISCLOSURE OF THE PREFERRED EMBODIMENT(S)

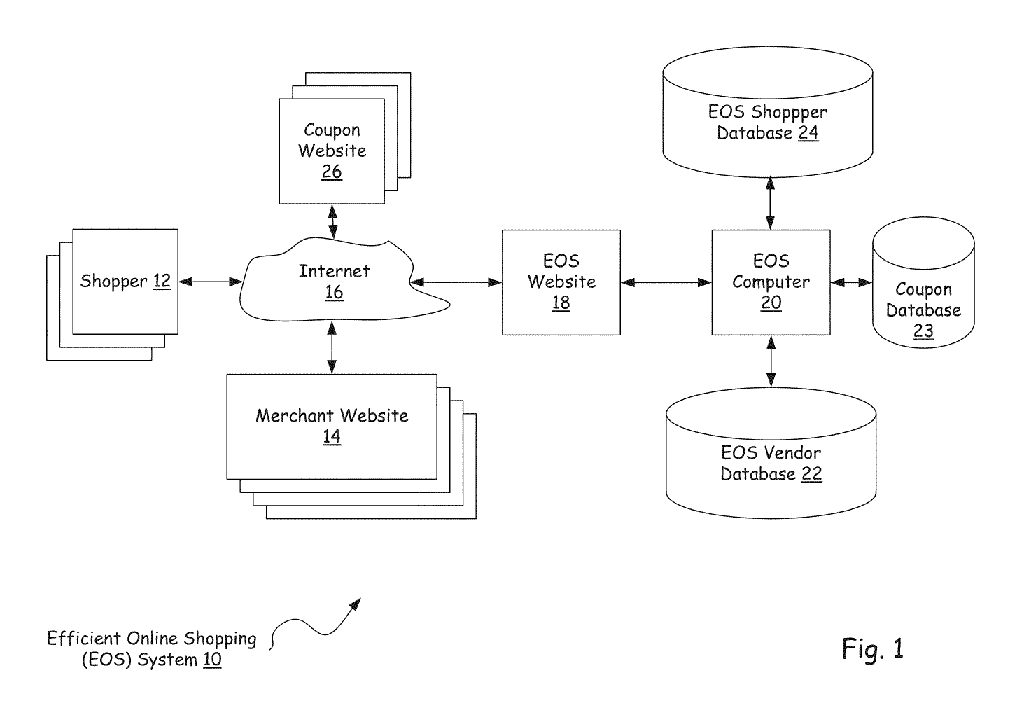

Referring now to FIG. 1, efficient online shopping (EOS) system 10 includes shoppers 12 and merchants 14 connected to the Internet. In a conventional online shopping transaction, shopper 12 would search for a product or merchant and eventually be directly interconnected with an appropriate merchant's website such as merchant 14, to review product information and costing and, if desired, enter into a sales transaction typically including the use of a so-called online shopping cart.

EOS system 10 includes EOS website 18 by which shopper 12 and merchant 14 may be connected. EOS website 18 may be supported by EOS computer system 20 which may or may not host the universal resource locator (URL) for website 18 but is connected therewith. Computer system 20 includes or has access to various databases such as merchant database 22, coupon database 23 and shopper database 24. Computer 20 also has access, via Internet 16 to one or more shoppers 12, merchants 14 and coupon websites 26.

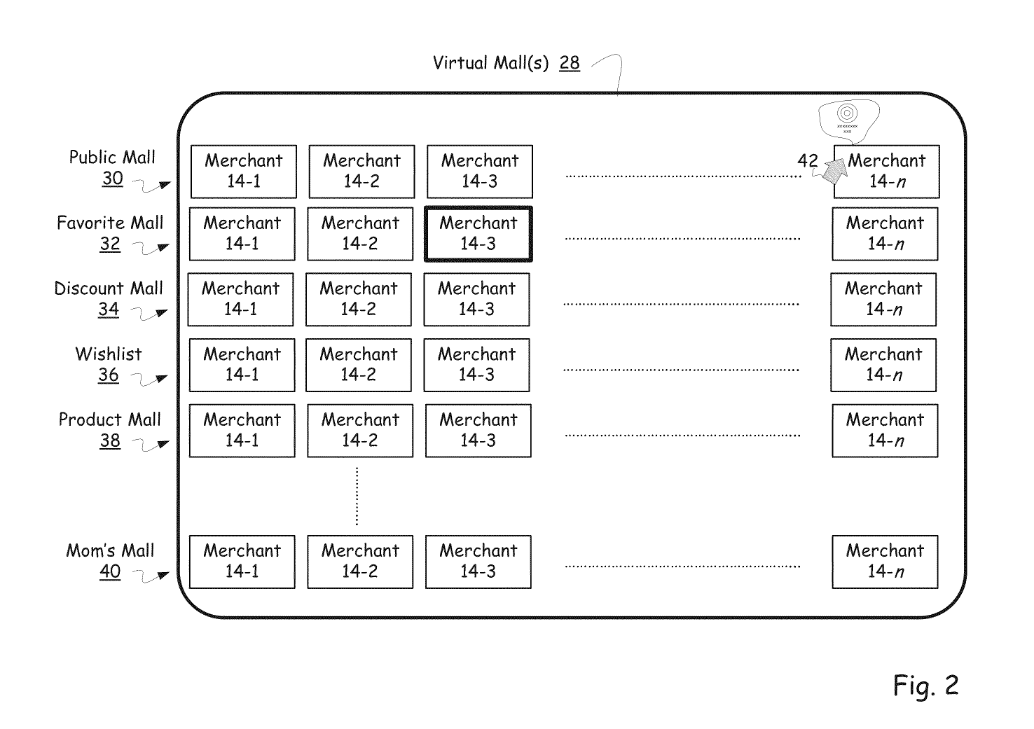

Referring now to FIG. 2, in some embodiments, one of the monitor displays available to shopper 12 when connected to EOS 18 may be one or more portions of virtual malls 28. Public mall 30 represents a row of merchant icons 14-1, -2, -3 . . . n which may represent many, if not most, online merchants. Public mall 30 may be a portion of a single display screen as illustrated for convenience in FIG. 2, or may be a single display and include multiple linked screens. For example, there may be on the order of 5000 or more online merchants, so it is likely to be difficult to display all such merchant icons at one time. Organizational techniques, such as alphabetic listings, product related and/or otherwise searchable listings may be provided for user 12's convenience to most conveniently reach the desired merchant icon 14-x. One or more merchant icons 14-x may represent a subset of merchants

Each icon may be or at least include an easily identifiable icon for the related merchant. For example, a bull's eye is a well-known trademark for Target stores. When shopper 12 hovers cursor 42 over the desired merchant icon 14-x, shown as icon 14-n in Public mall 30, the merchant's icon and/or additional text information such as “coupon available” may be shown on the screen.

There may be multiple mall displays, selectable by shopper 12, as the row of merchant icons 14-x indicated as favorite mall 32. This may indicate the favorite merchants selected by shopper 12, or previously or recently used by shopper 12 and/or merchant's proposed by EOS computer 20. Favorite mall 32 may have one or more product related icons, e.g., shoes, which when selected brings up a subset of further descriptors such as “athletic shoes”. By proper selection, shopper 12 can reach any particular merchant.

As described below in greater detail, in some embodiments, shopper 12 may be presented with various ways to reduce the cost of goods purchased, by for example, being made aware of various sales incentives such as price and/or shipping discounts and various other promotional codes that may be entered at the time of purchase. Although these incentives may occur in various ways, again as described below, one way to bring these discounts to the attention of shopper 12 is to provide a virtual mall, such as discount mall 34 which may be set automatically or by shopper 12 to display such discounts. For example, shopper 12 may choose to be notified when any of the merchants in her favorite mall have 30% discounts or free shipping or some other one or more criteria. Another way to provide this notification may be to separately or concurrently highlight a particular merchant icon, as indicated by the bolder line outline of merchant icon 14-3, favorite mall 32.

As noted above, there are many aspects of the efficient online shopping techniques disclosed herein. Many of the various techniques and embodiments may be combined in any number of ways. The scope of the invention herein is to be determined solely by the scope of the claims.

Additional malls may include wish list 36 which may provide a combined wish list from multiple merchants and/or indicate when any or selected promotions are available. Product mall 38 may indicate different merchants for the same product or category of products and/or the availability of promotions on a product basis. Still further, Mom's mall 40 may be one of a plurality of user specific malls in the same household.

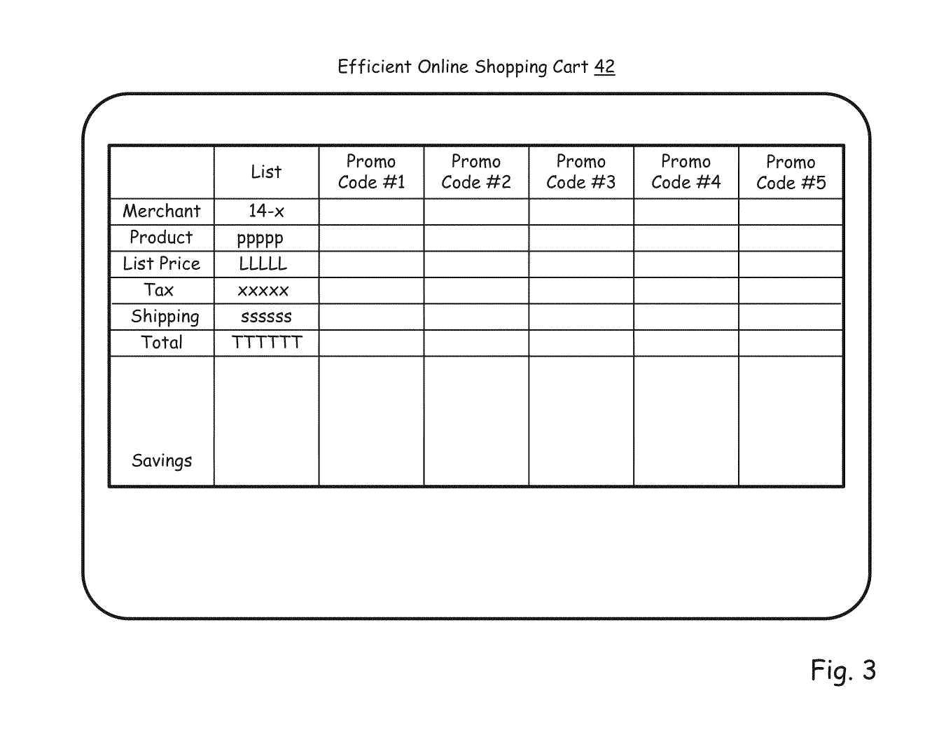

Referring now to FIG. 3, one important aspect of the online shopping experience is the shopping cart which lists the items to be purchased, the price, the shipping costs, tax and discounts, if any. EOS shopping cart 42, in some embodiments may be a merchant's shopping cart, a copy of the merchant's shopping cart, a separate EOS cart and/or a combination of any of these.

Shopping cart may have any number of formats, but for each format the typical components are an indication of the merchant, such as merchant 14-x, Product information, Price information, Tax, Shipping and Total. Another typical component is a mechanism for entering or used a promotion code, such as Promo Code #1. In a conventional shopping or checkout cart, shopper 12 would enter a promotion code in the space marked for such entry. The cart would be modified by adding new information or the list information would be changed to reflect the new information related to the entered promotional code.

In cart 42, the savings related to the entered promotion code could be displayed. Shopping cart 42 could also include an indication of the savings from the list total resulting from a particular promotional code. Shopping cart 42 may also automatically provide promotional code information from one or more promotions, such as codes 2-5 as shown. The codes could include publically available promotional codes collected by EOS computer 20 by crawling Internet 16 and may be stored in an associated database, shown for example in FIG. 1 as merchant database 22. Such codes could also include various types of non-public promotion codes obtained for the benefit of shopper 12 from one or more particular merchants, such as merchant 14-x.

The process of obtaining available, non-public promotion codes may be an important element in many embodiments and may be facilitated by presenting data related to shopper 12, for example to merchant 14-x, to help motivate the merchant to issue and/or make available the non-public promotional code. Such non-public codes may preferably be limited for use to a particular shopper 12, for a fixed number of uses —often a single use—to further motivate merchant 14-x to issue the non-public code knowing the code could only be used once, and by the identified shopper. Such non-public codes may not be available for use to the public and are expected to not be widely published like the so-called public codes, if at all.

Referring now again to FIG. 1, the data and techniques for the collection of the data in shopper database 24 useful in the negotiation of such non-public promotional codes will be described. The techniques may be different at different stages in the development of EOS 10 and may be varied for different shoppers 12 and/or different merchants 14.

In a well-developed EOS 10, that is, one with wide acceptance by merchants and shoppers, database 24 may maintain a profile of each shopper 12 related to both general and specific shopping experiences of shopper 12. One example of the data could be an indication of how often shopper 12 has shopped on merchant 14-x, how much money has been spent, how many sales incentives—and of what type—have been offered to shopper 12 and how many of such sales incentives have been part of a completed sales transaction. This data would obviously be useful to merchant 14-x who could be motivated differently to issue sales promotions to a loyal customer provided substantial repeat business, to a new customer to be one over or even to a customer of another merchant 14 who could be motivated to switch to merchant 14-x. This shopper profile may therefore be of value in negotiating non-public promotions for a particular shopper with merchant 14-x and/or with other merchants 14.

The techniques for collection of shopper profile data in database 24, coupon database 23 and merchant data in database 22, may also vary. In a fully developed system with cooperation from and/or substantial experience with at least some shoppers 12 and at least some merchants 12, sufficient data may be available to provide new, non-public promotion codes in near real time. That is, for example, shopper and merchant databases may indicate a) shopper 12 has a profile history including repeated use of promotion codes related to free or at least reduced shipping costs and b) merchant 14-x has a profile history indicating a willingness to automatically provide a free shipping promotion to shoppers shown to use such promotion codes on a regular basis provided that the profiled shopper (and/or product and/or shipping mechanism) meet other requirements.

In such cases, merchant 14-x may have made prior arrangements to provide EOS computer 20 the necessary relevant information which may be a copy of the specific merchant 14-x shopping cart being used during the purchase of a particular product for which the free shipping promotion may be used. If merchant 14-x has authorized EOS system 10 to automatically provide shopper 12 with a relevant promotion, the promotion code may be automatically entered by EOS 20 into the checkout cart being used during the checkout transaction in near real time.

Depending upon the circumstances and prior arrangements, in some embodiments a merchant 14-x may be provided with, and review, shopper profile data 24 to determine if the profile data is acceptable to merchant 14-x so that a relevant promotion may be applied. This may take a few seconds which most shoppers would consider acceptable. This approach gives merchant 14-x potentially greater control over the issuance of such promotions.

Still further, in some embodiments, the review and acceptance process necessary required for merchant 14-x to evaluate, decide and issue a non-public promotion to a particular shopper 12 may take a significant time. Shopper 12 may then be asked if they are willing to wait for a fixed period for EOS to try to negotiate a non-public promotion for a particular transaction. In this case, shopper 12 makes the first decision, is it worth waiting and merchant 14-x makes another decision, is the promotion worth granting.

The examples immediately above are related to a specific product which is some embodiments could be handled for each product in the checkout cart. In some embodiments, the promotions may be related to the total purchase, e.g., shipping charges, and/or a combination of both the aspects of one or more individual products as well as the total transactions.

Referring again to FIG. 1, in some embodiments, EOS 10 may have made arrangements with shopper 12 to provide at least some of the relevant data for shopper profile database 24. This may be accomplished for example by the use of a software plug-in downloaded by shopper 12 over internet 16 from an EOS website, such as website 18. The plug-in may permit computer 20 to obtain a copy of some of all of the transaction(s) between shopper 12 and one or more merchants 14, such as merchant 14-x. For example, computer 20 may have access to the actual checkout or shopping cart being used or at least access to a copy of that data and store it as part of database 24.

In some likely embodiments, database 24 may be populated first primarily with data from a shopper software plug-in downloaded from website 30 and eventually at least in part by direct access to at least some merchants 14. It is likely that shopper profile data 24 will often be provided by a mix between shopper provided data, i.e., via the software plug-in mentioned above and merchant provided data. Similarly, it is expected that although a substantial portion of shopper profile data will be provided via actual shopper-merchant transactions (whether or not completed) including searching and wish lists, while some of this data may be provided by other mechanisms including direct entry by the shopper and/or merchant on an EOS website, such as website 18.

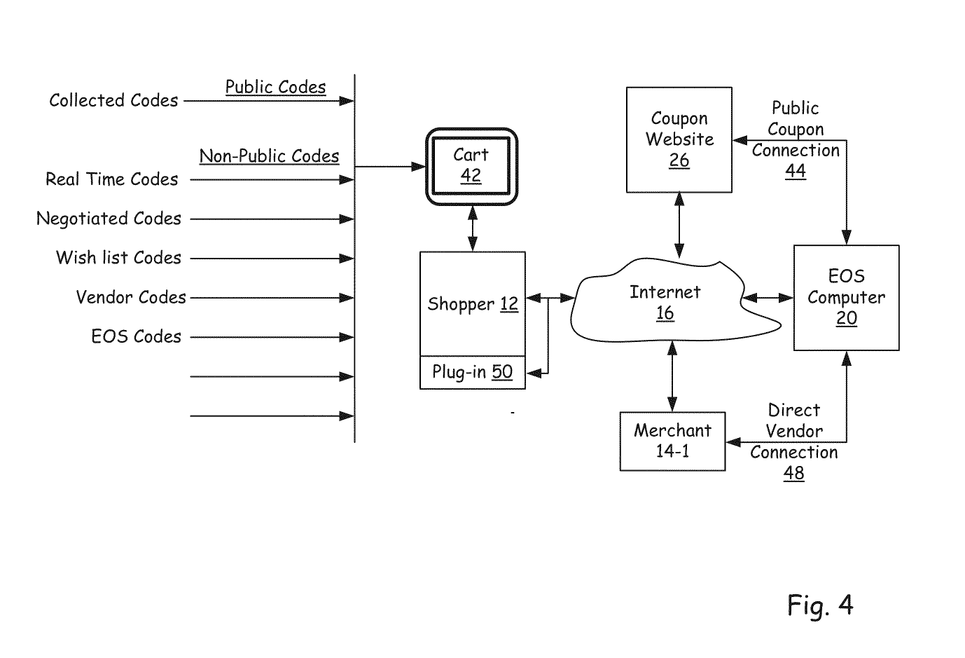

Referring now to FIG. 4, there are many sources and types of EOS system 10 facilitated transactions. Many embodiments facilitate such transactions promotion codes for promotions, coupons, reduced cost shipping or other advantages for shopper 12. Typically these advantages are implemented by providing a promotion code to be entered into the shopping cart, such as EOS shopping cart 42, during checkout.

Coupon website 26, EOS computer 20, merchant 14-1 and shopper 12 are connected at various times via internet 16. EOS computer 12 may also or alternately be connected directly to one or more sources of public coupons such as coupon website 26 via public coupon connection 44 and/or to one or more merchants, such as merchant 14-1, via direct merchant connection 48. Further, software plug-in 50 may have been downloaded by shopper 12 and provide alternate or additional connections to internet 16, one or more merchant 14 and/or EOS computer 20, for example to provide a copy of shopping cart 42 to computer 20. As shown, cart 42 is being displayed by shopper 12 but may have originated at merchant 14-1, EOS computer 20 and/or plug-in 50.

EOS computer 20, via internet 16 and/or coupon connection 44, may have collected many if not all public promotion codes in part by crawling the web. It is advantageous to verify at least some of the promotion codes. Further, at least some of the public promotion codes may come from merchants 14 for time limited sales, daily specials, volume discounts and the like via internet 16 and/or direct merchant connection 48.

Shopping or checkout cart 42 made available to shopper 12 may be provided by merchant 14-1 directly via Internet 16 and/or via computer 20 either as created by computer 20 and/or via direct merchant connection 48 from merchant 14-1. It should be noted that direct connections 44 and 48 likely include data transfer via internet 16, but may not be easily available to the public and may include specialized data transfer and/or encoding techniques.

Returning to cart 42 visible to shopper 12 during a purchase transaction may be the actual cart or a copy of the actual cart. The data in cart 42 includes sales and product data related directly to the possible purchase transaction as well as promotional data, such as price reduction, promotional codes and possibly rules and restrictions. Data shown on cart 42 may be provided in part by merchant 14-1 and/or computer 20. The data produced by computer 20 includes and/or is used to generate or modify data saved in databases 22 and 42 (shown for example in FIG. 1). The data collected these databases may in part be collected via internet 16, direct connects 44 and 48 and in great part from saving data entered on prior versions of shopping cart 42 from a plurality of shoppers 12 at various times.

A typical data flow would be for computer 20 to collect publically available data related to publically available coupons and/or from merchants 14, perhaps including shopping cart and other data specific to individual merchants. Such other data may include data related to requirements of one or more particular merchants 14 for providing a non-public promotion codes. For example, merchant 14-1 may provide data indicating conditions required for the granting of promotion codes, e.g., shipping discounts, such as automatic authorization to grant shipping discounts within certain shipping radii such as 100 miles for shipments up to a fixed weight, for fixed shipping methods or shipping costs. Other such promotion condition data may include techniques for negotiating shopper 12 specific non-public promotion codes such as profile data related to past online purchase activities of shopper 12 with merchant 14-1 and/or other merchants.

Such shopper and merchant profile data may conveniently be stored in shopper specific database 24 and merchant specific database 22 and/or in other database arrangements. The goal however, is to provide profile data to analysis to computer 20 to match public, non-public and/or to be negotiated sales incentives merchant 14-1 has or is willing to offer to shopper 12 together with data related to shopper 12 (particularly to past data transactions) that would qualify shopper 12 under conditions acceptable to merchant 14-1 to receive such sales incentives or promotions. Once computer 20 is able to provide an actual match, an appropriate promotion typically in the form of a promotion code is provided to shopper 12 for use during a transaction.

For example, if shopper 12 is in the process of purchasing a hammer from merchant 14-1 via cart 42 and a public or non-public promotion provided by merchant 14-1 is determined to be available for that purchase, the promotion may be applied to the proposed purchase by the entry of the appropriate promotion code(s) be entered by shopper 12. In some embodiments, the data entry may be fully automated, may require shopper 12 to select desired promotion codes and/or may require computer 20 to provide profile data to merchant 14-1 for analysis and approval before the data is entered into the transaction.

Promotion data, such as promotion codes or coupons may include, as examples:
Collected public promotion codes
Automatic real time non-public promotion codes
Negotiated non-public promotion codes
Public and non-public promotion codes applicable to products and/or other requirements in shopper wish lists
Promotions generated by merchants for other reasons
Promotion codes negotiated by EOS for EOS associated shoppers

The list of codes above is intended to be suggestive rather than exhaustive. EOS computer 20 is intended as an honest broker making promotions available to shopper 12 as a result of profile data provided shopper 12. Some of these promotions may be publicly available and some of these promotions may be made available by the actions of computer 20 in collecting and presenting shopper profile data to merchant 14-1. Such data may in part be previously collected shopper 12 profile data and some may be shopper 12 profile data in a wish list, shopping cart or other online shopping related data related to shopper 12 and made available to EOS computer 20. Further, although EOS computer 20 is currently described as a multi-merchant computer, EOS 20 may be a specific computer provided as a service to merchant 14-1.

Various general EOS techniques have been discussed above and more such techniques will be discuss below in different and/or greater detail. Such descriptions are intended to be combinable in multiple ways, generally using the advantage of collected profile data made available to a third party for use in obtaining public, non-public and/or negotiated promotions from merchants to be conveniently provided to one or more shoppers. Ancillary related techniques are described which may be combined with other techniques and or used alone.

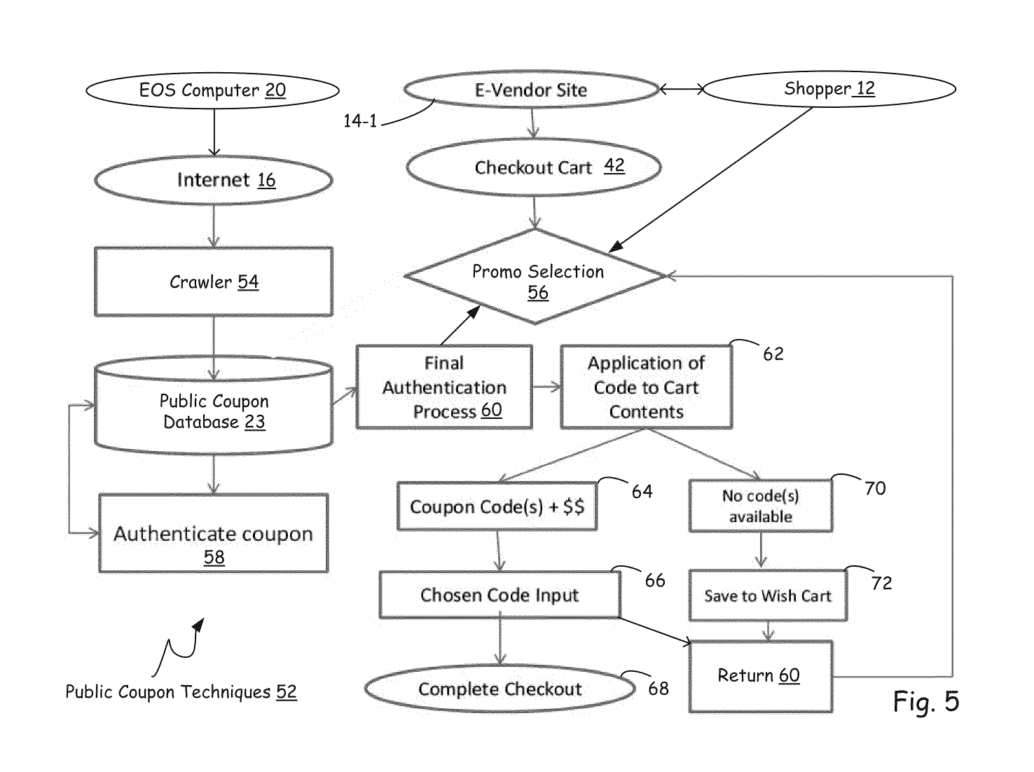

Referring now to FIG. 5, on overview of public coupon (and/or wish list) techniques 52 is described in which EOS computer 20 via a connection to internet 16, uses web crawler 54 to create public coupon database 23. Database 23 may be included in databases 22 and 24 shown in FIG. 1 and/or include promotion codes for coupons and/or promotions collected by other techniques. Preferably, coupon authentication technique 58 may be used to authenticate the validity and availability of data in coupon database 23.

In this process, shopper 12 connects to merchant 14-1 (via internet 16) to make online purchases and eventually populates checkout cart 42 with one or more products. One or more promotions may be applied from EOS databases, such as coupon database 23, preferably via a final and/or current authentication process 60 to promotion selection 56 typically for display in cart 42. Shopper 12 may select one or more promotions which are then applied in by application box 62 to cart 42 by for example incorporating promotion code and price savings as shown in box 64, other processes may be applied as illustrated by box 66 such as entering the promotion code into the proper box in cart 42 after which cart check out may be completed, box 68 or the process will use return 60 to process other requirements of the transaction.

During operation of application box 62, if no promotion code is applicable, box 70, in some embodiments the product may be saved to wish cart 72 so that when appropriate promotions are detected, they may be made available to shopper 12. Return process 60 may then return to cart 42 and promo selection 56 for remaining items or steps required, such as purchasing the selected items with a different promo code if available and/or selecting different items for purchase evaluation or other requirements.

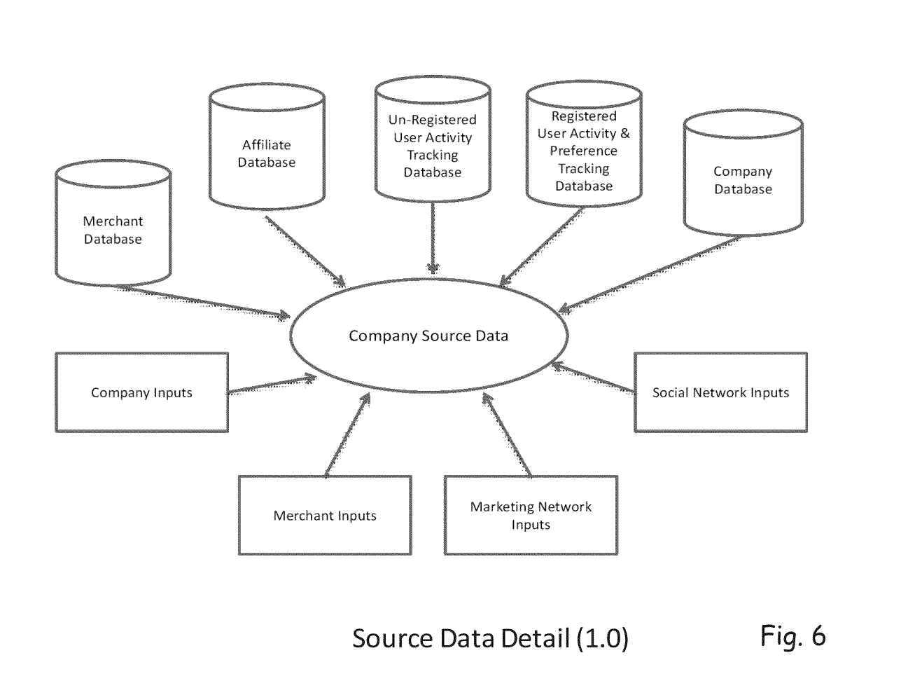

Referring now to FIG. 6, an illustration is provided for the collection of company source data, that is, EOS data.

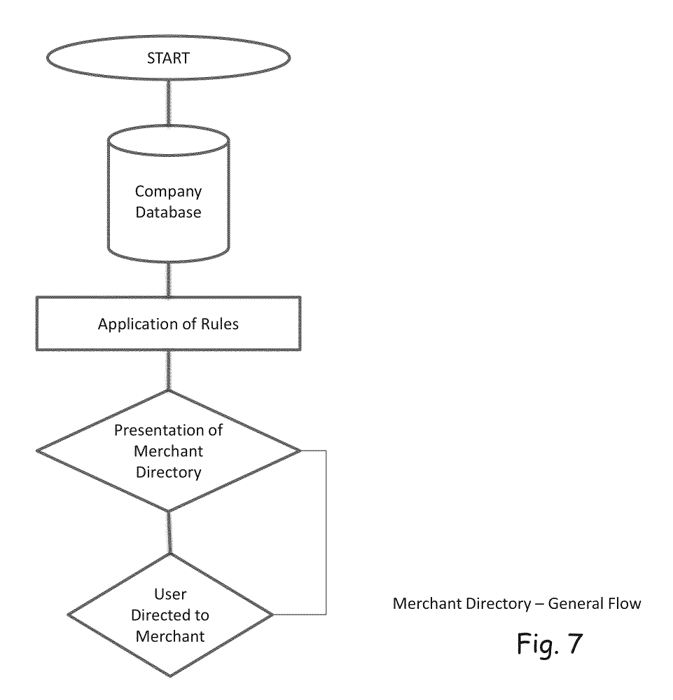

Referring to FIG. 7, an flowchart is presented for providing merchant icon information 14-x for each merchant displayed on at least one of the virtual mall(s) 28.

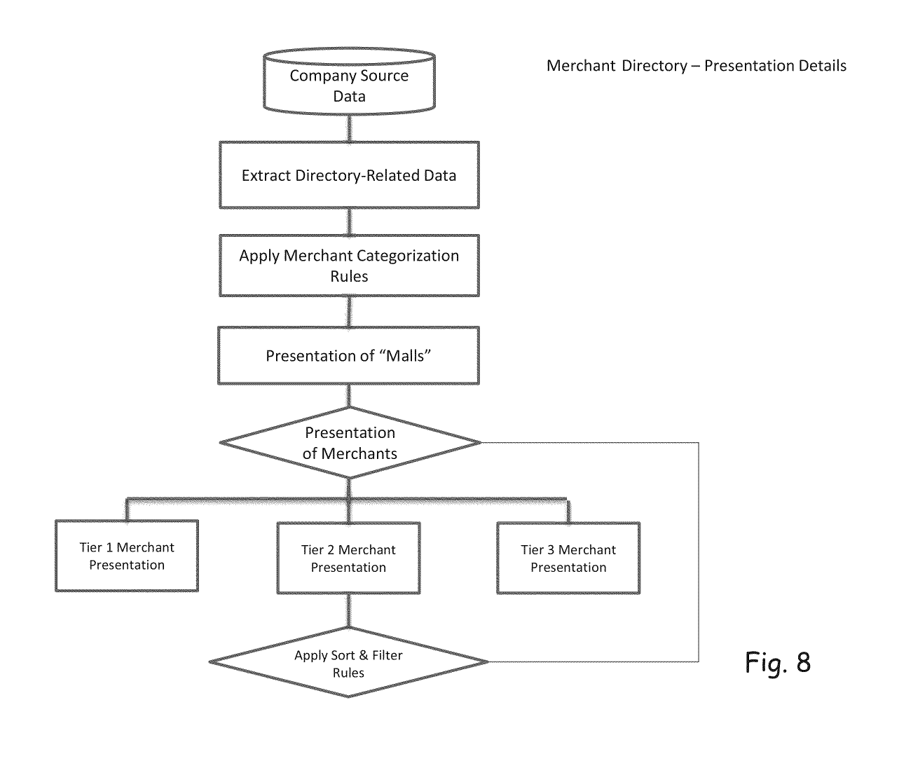

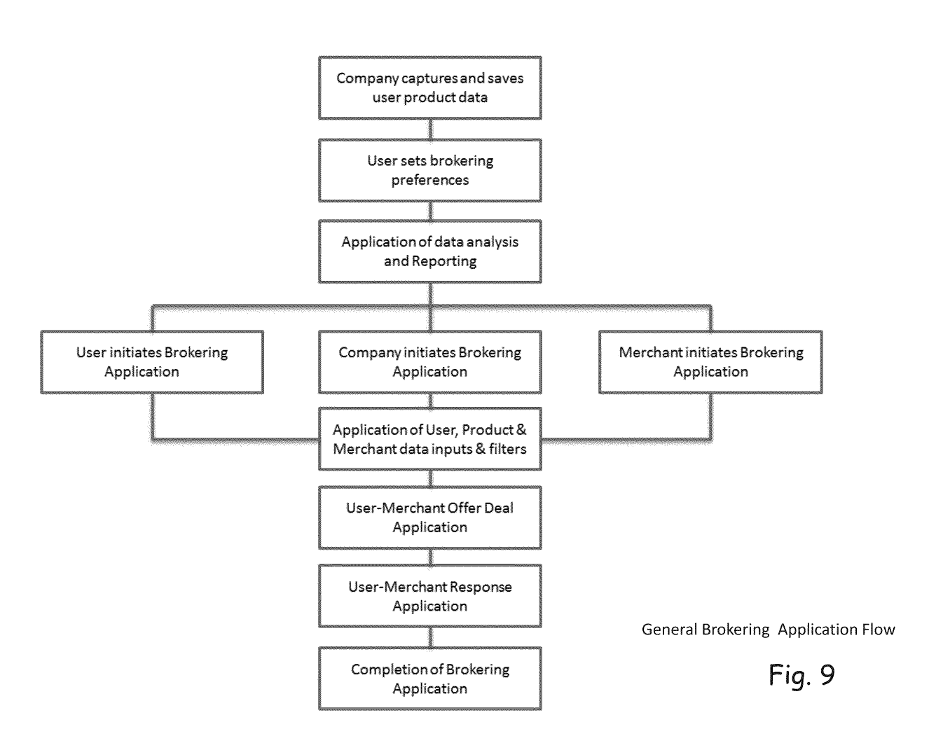

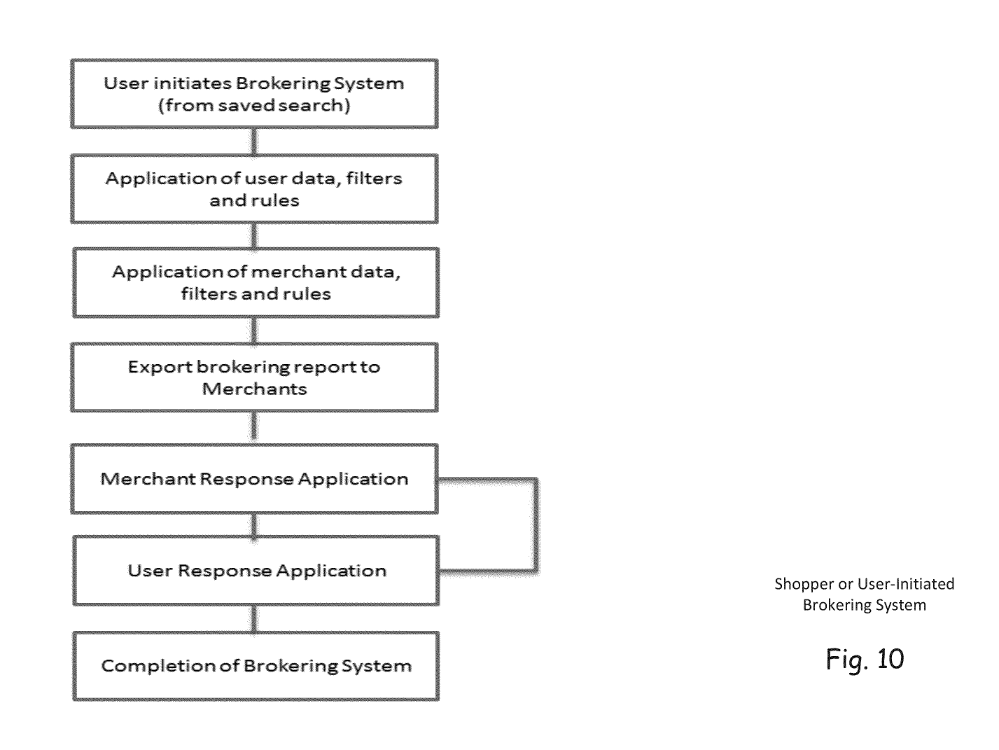

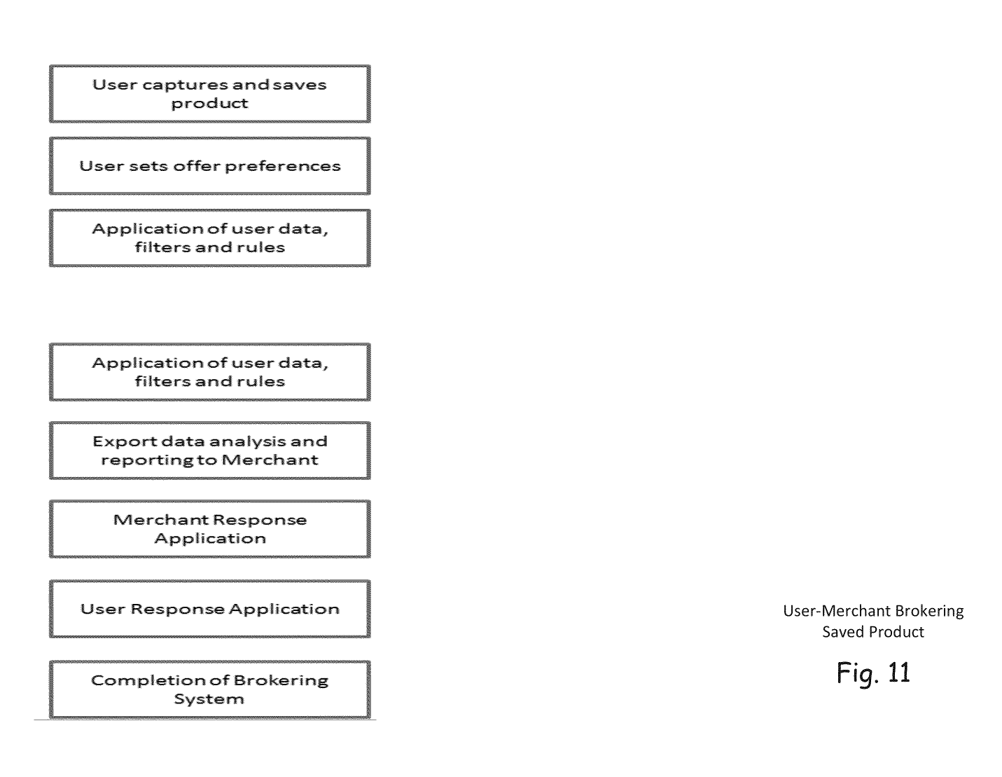

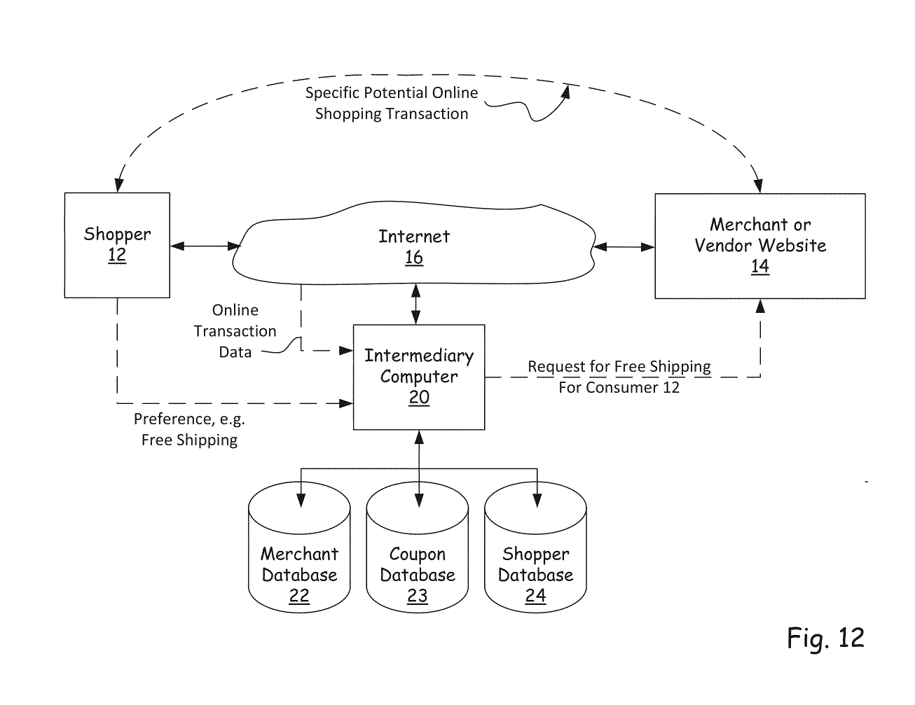

Referring now to FIG. 8, a flow chart is provided for the presentation of the various merchant or merchant icons 14-1 for merchants displayed on at least one of the virtual mall(s) 28.

Referring now to FIG. 9, application flow for a general brokering scenario is illustrated.

Referring now to FIG. 10, application flow for a user initiated brokering system is illustrated.

Referring now to FIG. 11 is an illustration of a User-merchant Brokering system for a saved product, e.g., using a wish list.

Referring now to FIG. 12, an exemplar transaction is illustrated. In this transaction shopper 12 is connected via Internet 16 to merchant website 14 and is involved in a specific potential online shopping transaction. For example, shopper 12 may be looking at a particular product offered for sale by merchant. During some phase of the potential transaction, perhaps after the table is listed in a checkout cart provided by merchant 14, shopper 12 may decide that the shipping charges are too high for shopper 12 to be willing to complete the transaction.

Shopper 12 may contact intermediary computer system 20 to indicate a preference (or requirement) for free shipping of the table before agreeing to by the table from merchant 14. In addition to the preference for free shipping, computer 20 may have collected data from previous online shopping transactions, and/or developed a shopping profile for shopper 12 from previous online transactions, one or both of which may be stored in one or more databases accessible to computer system 20, such as shopper database 24. This shopping profile and data may be useful to merchant 14 in a decision making process to determine if merchant 14 is willing to grant certain sales incentives to shopper 12.

For example, if the data indicates that shopper 12 has previously requested free shipping and, when free shipping has been offered, has consummated previous online purchase transactions, merchant may be motivated to grant a request from shopper 12 for free shipping, at least for certain categories of products. Similarly, the data may indicate that shopper 12 may be considered an abuser as a result of requesting free shipping for all products, and/or does not consummate the transactions with sufficient consistency.

Merchant 14 may have rules for processing requests which consider other aspects of shopper 12 shopper profile, for example, by continuously asking for other discounts and/or using bad credit cards or the like. Computer 20 may be used to collect online transaction data indicated by (or assumed to be) useful to merchant 14 to the process of determining whether to provide the requested preference in a specific potential transaction to a particular shopper 12.

Alternately, the potential online shopping transaction may be a non-real time transaction such as a wish list. Shopper 12 may save a product in a wish list or other mechanism for indicating that the product is being considered for purchase and/or any preferences requested or required for consummating the purchase.

If the online transaction is occurring in real time, i.e., shopper 12 is currently viewing the product and requesting a preference such as free shipping, merchant 14 may also make the decision to provide the preference, for example, free shipping also in real time as part of the checkout process, so that the transaction can be completed immediately. Alternately, if the potential transaction is not a real time transaction, such as a product listing in a wish-list as discussed above, shopper 12 may be notified when (and if) merchant 14 offers the requested discount. The notification may be in the nature of—and/or include—a link so that selection of the link related to the merchant offer may create a real time transaction which may then be completed in a normal manner, but with the free shipping or other requested discount.

Preferably, computer 20 may have also developed a profile of merchant 14. For example, this merchant profile may indicate that merchant 14 does not have a pattern of offering a particular type of discount when requested and/or only does so slowly, or offers reduced shipping charges when free shipping has been requested. This information is quite valuable to shopper 12 who may choose to view the same or similar products at other merchant's website.

Alternately, computer 20 may transmit the request to multiple merchant's for the product and forward a link to another merchant 12 willing shopper to offer free shipping at the same or at least an acceptable price.

Further, computer 20 may also maintain a database of publically available sales incentives by product and/or merchant, for example in coupon or promotion data base 23 so that shopper 12 may include the availability of such discount information in any online shopping decision.

Referring now generally to FIGS. 1-12, in operation, the various embodiments typically provide user-directed, e-commerce efficiencies with centered about shopping cart 42 and may include automatic coupon code search-and-capture software, one or more user-specific Virtual Mall(s) 28 including one or more public, favorite, discount, wish list, product and family member malls which may include coupon highlighting and brokering, wish cart storage and retrieval, and account tracking, filing and notification activities.

These activities may be available for transactions made in computer and tablet/smart phone formats.

The coupon optimization software may automatically search, capture, authenticate and input valid electronic coupon/promotion codes into the redemption box in shopping Cart 42 at checkout in an e-commerce transaction.

Shopper 12 may download software from EOS website 18 which may be as a web browser-plug in. Shopper 12 may have the option of selecting an EOS Icon at shopping cart 42 of an e-commerce transaction. The software may then present a specialized display of all available electronic coupon codes, including publically available codes and next to them, a dollar/cent computation of the savings based on the items and/or total money spent in cart 42. Shopper 12 may then select the code(s) she wants to use and the selected code may then be inserted into the appropriate box.

Public coupons, promotion codes may be collected by crawling internet 16 for electronic coupon and promotion codes by, for example, targeting e-merchant sites, affiliate marketing sites, blogs, coupon posting sites. The selected codes may be used to populate a database such as coupon database 23. EOS 10 system may also request shopper specific discounts and promotion codes directly from e-merchants 14.

Authentication processes may be applied confirm the code's validation by, for example, contacting relevant e-merchants 14, automating the request format, and/or performing a “test” transaction. Valid codes will remain in the coupon database. Invalid codes, such as fraudulent, expired and or single use codes may be eliminated. Valid codes may be sorted by the universal resource location (URL) designations for each merchant

During use, software plug-in 50, if downloaded from EOS website 18 and selected by shopper 12, may take a snapshot or other copy of cart 42 which may be stored in one or more databases which may be searchable by merchant URL, such as merchant 22, coupon 23 and/or shopper 24 databases. Additional coupon codes, such as user-specific VIP promotional codes (discussed in more detail elsewhere herein) may be made available with the appropriate merchant URL when searched.

The savings of each code to the shopper 12 may be calculated and applied to cart 42 and/or a copy thereof for selection by shopper 12. Corresponding data, such as an updated copy of cart 42 may be stored in one or more databases associated with EOS computer 20.

shopper database 24, for example, may be used to store purchase histories so that preferred coupon codes, preferred merchants, sum totals of e-commerce (by merchant, by coupon-code), sum totals of savings (sorted by month/year) may be also be stored. Such information may be used to broker better promotional savings and related coupon codes for each shopper 12.

In some embodiments, a copy of checkout cart 42 may be saved to a shopper specific “Wish Cart”, for example on EOS website 18 when shopper 12 does not to complete the checkout process on the e-merchant site. The saved copy of cart 42 may be accessed at a later date for use with a different coupon code, as a reference to shopper 12 of desired purchases, and/or for use in brokering a better coupon for shopper 12 in a later transaction.

There are at least 2 techniques which may be used with regard to saved copies of a wish cart version of cart 42, when there are no promotion codes available and/or when the available promotion codes provide insufficient incentive for shopper 12 to complete her e-commerce transaction.

When no code is available, the shopper may have be presented with the option to save cart 42 for later use and the option to be notified if coupons become available for products on the saved version of cart 42. When a new/valid coupon code becomes available, shopper 12 will be notified and she may either return to merchant 14-1 to continue checkout on her original cart (if possible) and/or repopulate her cart with her original items. The EOS 10 coupon code will automatically input into the appropriate code box.

If shopper 12 selects “Yes, Find me another coupon,” a timed mechanism may be used to review saved Carts on a regular basis and report if a new code becomes available. Shopper 12 may be notified by various mechanisms including email as well as by visual notification in virtual mall(s) 28.

In some embodiments, cart 42 or the copy thereof may formatted for compatibility with merchant 14-1 to facilitated negotiation for and implementation of improved promotion codes for shopper 12 when negotiated with and approved by merchant 14-1.

The data contained in the copies of cart 42, such as items purchased, coupons rejected, total spent, coupon selected to close transaction, etc., for a profile of shopper 12 and may be used to broker user-specific coupons to close the transaction as discussed herein. This database of cart 42, whether completed or in wish list form, provides important aspects of a profile of shopper 12 and may to complement other user related data tracking purchasing history, coupon preferences and other e-commerce behaviors.

In some embodiments, arrangements with one or more merchants 12 may be used to automatically repopulate and modify a saved cart 42 use in the checkout process to complete the purchase transaction.

EOS system 10 may try to obtain a better promotion on behalf of the shopper 12 by making a copy of the data on a particular version of cart 42, such as by presenting cart 42, and/or a saved copy thereof to merchant 14-1 so that merchant 14-1 may offer a new coupon as an incentive for shopper 12 to complete the transaction. This may apply when no codes available and/or when the codes available do not interest the user.

When valid codes and money saved are presented to shopper or user 12, a “WISH CART” version of cart 42 may be presented with a new option: “Brokering a better coupon deal”. The display of cart 42 may include both Wish Cart and Broker options. User 12 may select either one of these options, regardless of whether or not coupon codes are or are displayed If user 12 clicks on “Broker,” user 12 may be if she wants EOS 10 to solicit merchant 14-1 for a one-time use, specific coupon to complete the transaction. If the user does not click the “BROKER” option, user 12 may continue to use cart 42 as usual including saving cart 42 as a Wish Cart option for use at a later date or choose an already displayed or listed coupon. If the user selects “BROKER, ” she may be asked for the promotional incentive she requires to close the deal i.e. an “Agree To Buy” code.

Options for may include: “Free Shipping, ---% off, ---$$ off, ---% ---item, ---$$---item.” The user inputs the parameters she would agree to purchase the items (giving specific numeric) and confirms her agreement to the terms of “Agree To Buy” (which is to complete the transaction and purchase the items in the Checkout within a period of time).

The user may be notified within a predetermined time (e.g. 24 hours) if she has received a coupon code from e-merchant 14-1 and/or if she has received her Agree to Buy coupon and thus, the Checkout has been completed by the e-merchant (if available by the e-merchant). She may be notified via the same process used with a Wish Cart, by email and/or by a highlighted/color-coded Wish Cart sign. The user will likely have a pre-determined time (e.g. 24 hours) to complete the checkout on e-merchant site 14 (or via a copy of cart 42, if available).

If e-merchant 14-1 either does not offer any additional coupon codes or does not meet the predetermined “Agree-To-Buy” coupon code, the user can choose to have EOS 10 search for coupon codes from its database at a later date or she can choose to file the Cart as a personal reference.

In operation, EOS 10 may electronically contact e-merchant 14-1 with the terms of the offer, a copy of the user's Checkout and any highlights, as deemed relevant and gathered by algorithms, of the user's e-commerce history with e-merchant 14-1. A copy of the request is sent to an EOS database and after a pre-determined period of time (e.g. 24 hours) the request may be withdrawn from merchant 14-1.

If the “Agree To Buy” coupon code is timely accepted by the user, EOS 10 may forward the appropriate information to e-merchant with approval to complete the transaction. Either e-merchant 14-1 can complete the transaction (based on credit card pre-approval and account overlap and the like) or the user can be directed to complete the transaction within a predetermined time frame (e.g. 24 hours). The “Agree To Buy” code and confirmation data may be sent to an EOS database, to be shared (as relevant user history) for similar requests to the same e-merchant.

If a different-than-Agree-To-Buy coupon code is received, the user may be notified (via email and/or highlighting) that she has a pre-determined time to complete the transaction. The coupon may have a unique one-time use encryption code that expires within the same time period as the offer. The code may be stored in computer 20. If the user accepts the offer, she may complete the checkout cart transaction as required in the Wish Cart process. The one-time use code will be input in the appropriate code box. Coupon code and money saved data may be sent to user database 24 (to be sorted by Brokered Coupon savings/coupon codes and included in whole saving/code tallies).

In most embodiments, EOS 10 will not re-broker the same cart. Abuse, misuse or e-merchant complaint of the Cart Brokerage application can cause user Brokerage options to be banned and the Broker option to be not made available in the display of cart 12 for shopper 12.

In some embodiments, user-specific VIP coupons (to be placed exclusively in the user's account) from favored e-merchants that are automatically entered into the user's list of available coupon codes. Shopper 12 may receive a notification (via email and/or via highlighting to her VIP Coupon Box) that she has received, upon a requested VIP coupon for her exclusive use while using intermediary or EOS computer 20. VIP coupons may be updated and validated at the merchant's direction.

A VIP coupon request may be based on User Database Analysis algorithms. Based on the analysis of the user's buying history and patterns (e.g. favored e-merchants, preferred coupons, percentage of spend at particular merchants vs. all merchants, etc.). Computer 20 may identify loyal customers and their preferred coupon codes to favored e-merchants of merchants with the expectation that a loyalty VIP reward system will help both EOS system 10 and the e-merchant with customer retention. Single use codes and reusable codes (to be set with pre-determined expiration dates) will be encouraged.

EOS 10 may automatically contact a representative or e-merchant or merchant 14 and present the user data and request for coupon. If the e-merchant does not provides a VIP coupon code, the rejection notice (and coupon code) may be stored in the User Database. The user history based on date of rejection (to show if the lack of a VIP coupon affected user behavior with that e-merchant). Based on the data analysis, EOS 10 may consider whether to revisit the e-merchant with another request for VIP coupons.

If/when the e-merchant provides a unique user VIP coupon code, EOS 10 may imbed the VIP code into the user's VIP Coupon file (in her account and/or shopper profile in the appropriate database). The VIP code will be identified to the use although its coding will remain unseen (as a security measure so the coupon code isn't shared). If the coupon is one-use, the code will expire as directed and moved into the “Used/Expired VIP code” field of the file. If the code is reusable but with an expiration date, EOS 10 may automatically request an updated coupon (at a predetermined date such as “1 week before expiration”). EOS 10 may present all data relevant to the VIP Coupon renewal. EOS 10 may track the user history based on date of VIP Coupon issuance (to show if the VIP coupon affected user behavior with that e-merchant).

To enter a VIP coupon code into the EOS 10 Coupon Display, when the user clicks on the appropriate Icon, computer 20 may search both the EOS 10 Coupon Database and the user's VIP Coupon Account. If a VIP coupon is available, it may be included and its savings shown in the display line-up, e.g. shopping cart 42. If the user chooses the VIP coupon, an encrypted coupon code may be input into the appropriate Coupon/Promo Box. The coupon code and money savings data may be saved in the EOS 10 User Database (to enable tracking and analysis of ecommerce behavior, history and savings totals).

VIP coupons may be voided for abuse, misuse or at the discretion of either the e-merchant or EOS 10. VIP Coupons can be received directly from the e-merchant. The customer may be given the opportunity to edit their VIP coupons (e.g., delete VIP coupons no longer interesting to them). VIP coupons may not be transferrable or accessible to the EOS 10 Coupon Crawler or EOS 10 Coupon Database.

In some embodiments, shoppers may select their favorite merchant portals (e-merchant icons with direct links to the e-merchant website) to create their own Virtual Mall while EOS 10 highlights which of their selected e-merchants has coupon codes available.

shopper 12 may sign into their EOS 10 Account and select the “Virtual Mall” application. If this is the first time the user has used this application, the user may first needs to set up their Virtual Mall by selecting from a pre-established list of e-merchants. All selected e-merchants may be displayed in the “Virtual Mall” blueprint as e-merchant icons. Each e-merchant icon is a direct link to the e-merchant website. By clicking on the icon, the user is directed to the e-merchant site of her choosing.

When the user rolls her mouse over an e-merchant icon (but does not click on the icon), a list of current coupon codes available for that e-merchant may be shown to the user. This enables the user to decide which site she wants to shop at if/when her shopping is dependent upon the added coupon savings. This feature is particularly useful to the user during an “Impulse Shopping” experience. VIP coupon codes may be included in the highlighting feature.

Once the user has decided where she wishes to shop (based on coupon-code offerings or not), the user clicks on the icon and may go directly to the e-merchants website. From here, the user should engage the EOS 10 software as directed in the Coupon Optimization section.

The Virtual Mall may be stored in the web-based EOS 10 Account. To set up a Virtual Mall, EOS website 18 may offer an exhaustive list of e-merchants and their branded icons (if no branded icon is available, compressed e-merchant names may be on a standardized block). The user may check each e-merchant site she'd like included in her Virtual Mall display. The Virtual Mall may be exclusively designed with the store icons, spaced evenly apart (much like Apps on an Apple device).

The Virtual Mall Display (version 1.0) may offer a simple 1-dimensional frame with icons inside. The user will be able to manipulate the placement of her selected icons by floor in a 2-dimensional frame (version 2.0). The user can edit her selections in her “Account Preferences” setting. To be routed to the e-merchant website, the user simply clicks on the icon. The e-merchant website may pop up in a new/second internet browser page. The EOS 10 Virtual Mall page may still available for quick access.

On the Virtual Mall page, when the user rolls her mouse over each icon, a highlighted display may float automatically above the icon with a list of all available coupons (as defined by the EOS 10 Coupon Database). The e-merchants with VIP EOS 10 coupons may be highlighted uniquely (e.g. placed on the most prominent “VIP Penthouse Floor” in version 2.0) and VIP codes may be included in the roll-over coupon code listing.

Once the user has designed her Virtual Mall, EOS 10 may solicit VIP coupons from each of the selected merchants, presenting any/all relevant user purchasing history and behavior (with the intent to get the best coupon code for the user's history).

In some embodiments, dedicated email inbox for user's shopping needs may be provided. EOS 10 may organize all VIP coupon offers, brokered coupon offers, coupons about to expire, receipts, current sale notices from favored e-merchants (e.g., those in Virtual Mall). This email service may be made available for user as the email address for all e-merchant, e-commerce transactions (to free up the user's personal and business email addresses from e-commerce clutter).

In some embodiments, a user account application may captures and file Completed Checkout Cart snapshots and makes them available for filing under user-edited categories (e.g. Taxes, Personal, Gifts, etc). Receipt aggregation may be made available by YTD, last 2 months, last 30 days, last week, most receipt. An end-of-year report may available with figures of how much money saved in coupons, where the money was spent, what stores offered the most coupons, etc.

In some embodiments, users may track membership and loyalty programs that offer additional savings to ecommerce transactions (e.g., AAA, AARP) and inputs appropriate codes, when/where available.

Referring again to FIGS. 1-12, further descriptive material is provided below to enhance the disclosure of some of the embodiments presented above and to disclose aspects of still further embodiments.

At least some of the embodiments provide an integrated method of user-directed, e-commerce efficiencies through various shopping cart and front-end optimization applications to increase ease and efficiency of user ecommerce transactions. The various techniques provide users with front-end and shopping cart efficiencies based around the centralization of merchant information and the combination of multiple systems which include
a.) comprehensive, multi-tiered directory of e-commerce merchants;
b.) search, sort, filter and highlight capabilities within the visual directory;
c.) a customizable, user-specific Virtual Mall application;
d.) user-specific coupon application;
e.) centralized environment for social sharing of rating and reviews of merchants, offers, and user transactions;
f.) offer-brokering system;
g.) wish cart storage and retrieval system;
h.) notification and email organization system; and
i.) data analysis of user preferences, behaviors and interactions within the user-specific Virtual Mall system and the comprehensive visual directory.

These techniques include the aggregation of multiple data sources, user preferences, and computer applications between Company (EOS 10) and merchants (merchants 14), Company and affiliate networks, and Company and users (shoppers 12).

These techniques facilitate user efficiencies in e-commerce transactions by providing a comprehensive visual and interactive presentation (e.g. visual malls 42) which may include all e-commerce companies and their valid electronic coupon/promotion codes. This visual presentation is a resource directory and provides multiple-tier view options with varied levels of detail, information and accessibility for each merchant. The ability to quickly access and compare specific merchant detail (e.g. coupon, sale and shipping offers and/or additional merchant information) provides users with optimizations at the front-end of their shopping process as they choose merchants for online purchases.

The following outlines may provide useful disclosure of implementation details appropriate for various embodiments.

In some embodiments including virtual mall(s), users visit website and have immediate access to a comprehensive, full listing of e-commerce merchants, organized by a visual presentation with Company-designed, interactive graphic elements. Each merchant is represented individually. The user is able to interact with each merchant on three-different element tiers, with each tier providing additional levels of data, information of and/or interaction with the merchant by the user.

Tier 1: Merchant Graphic Element
Visible immediately to all users, all platforms
Includes streamlined presentation of key merchant information
Includes public merchant information (name, logo)
Includes interactivity of public merchant information (link to URL)

Tier 2: Enriched Graphic Element
Visible when user hovers over Graphic element (on desktop) or clicks Graphic element (on table or smart phone)
System enlarges merchant Graphic Element size when user hovers or clicks
System shrinks enlarged element to original merchant Graphic Element when user moves mouse off, clicks “close” or clicks open space around enlarged element
Includes additional merchant information and functions to optimize shopping by further enable quick comparisons of key shopping preferences:

All Tier 1 Information and Functions
Public Information (including shipping information), Company data (including user ratings, user-specific coupons), Affiliate data (including full coupon and offer listings, banner advertisements), merchant data (including products, shipping information, banner advertisements)
Ability to share merchant and offer information via social media networks (including Facebook and Twitter)
Ability to add store to User-Specific Virtual Mall (ref. 1.1)

Tier 3: Merchant Detailed Page Element
Visible when user clicks and/or double-clicks on merchant Graphic Element or Enriched Graphic Element
Provides most comprehensive merchant information, functions and interactive features:
All Tier 1 and Tier 2 information and functions
Additional data from Company database (including user reviews, categorization lists, recommendation lists), aggregation of public information with Company rules, (including product recommendations)

Ability to Perform Additional User-Specific Functions (Including Add Reviews and Ratings)
The system presents and acts upon data related to users, merchants, offers, and affiliate networks. This data is aggregated from Company Source Data from one or more of the following sources (FIG. ______):

Company Database;
Custom data input using the system, by any valid system user including but not limited to: registered users, unregistered users, merchant users, Company internal users, affiliate network users, network or marketing agency users;
Data collected from one or more merchants;
Data collected from one or more affiliate networks;
Data collected from one or more marketing networks;
Social networks such as Facebook and Twitter.

The above data may be presented to users of the system or users of other systems (such as social networks and affiliate networks) based on Company specific logic to handle various scenarios and user interactions. The system may perform data cleansing, filtering, consolidation, routing, reporting, logging, auditing and analytics based on Company specific logic.

### Comprehensive Merchant Directory Addendum A

### (Categorization)

Synopsis: On default, merchants will be presented in logical groups to help organize their display and user interactions. Group will be based on merchant data, network data, Company data, and/or user data.

User Experience: merchant graphic elements are located within larger Company-designed graphic elements to create a “Mall” experience. Malls are defined by logical category assignments. merchants are assigned within Malls. Users experience the Malls and upon hovers and/or clicks, will be able to quickly view which stores are within the Mall and then, view and/or access all merchants through the Directory Process (ref 1.0).

Technology Architecture: The system will define logical groups that can be used to organize merchants. The groups may be based on merchant data, affiliate network data, Company custom data, and/or user custom data. The system will store, maintain, and present the merchant and group relationships based on Company solution design and user interaction with the system.

### Merchant Search, Sort, Filter and Highlight Functions

Synopsis: Various search, sort, filter and highlight capabilities for merchants within the merchant Visual Directory. Method enables user to search for merchants using various designates; to sort merchants and/or merchant search results by various designates; to filter merchants and/or merchant search results by various designates; to highlight merchants and/or merchant search results by various designates. Designates might include product categorization, coupon types, shipping offers, user ratings, top stores, alpha list, and user-specific coupons (see 1.2.1).

User Experience: User performs search for merchant thru various search inputs and receives results which can be sorted, filtered, and/or highlighted by various pre-determined designates. User can alternate designates, switch between designates, apply multiple designates and/or delete designates based on user-preference and control the order, content, quantity, visibility and/or organization of merchant search results. Sort, filter, and/or highlight functions can be applied and/or experienced at all three tiers of the merchant Visual Directory (ref. 1. 1-3 above).

Technology Architecture: Search is done dynamically by querying all available databases. All matching merchants are collected, filtered thru EOS 10 rules, organized and then shown to the user to guide their shopping needs.

### Product Search, Sort, Filter and Highlight Functions

Synopsis: Various search, sort, filter and highlight capabilities for products within the merchant Visual Directory. Provides the ability to enter product name and receive visual results of product

User Experience: User performs search for product using various text inputs and receives results which can be sorted, filtered, and/or highlighted by various pre-determined designates. Products are displayed in graphical elements tied to the merchant selling the product. Product graphical element includes detailed information that makes comparison between merchants easy, including price, picture, applicable coupons, tax rate and shipping fees. User can alternate designates, switch between designates, apply multiple designates and/or delete designates based on user-preference. User has ability to control the order, content, quantity, visibility and/or organization of product search results. Sort, filter, and/or highlight functions can be applied and/or experienced at all three tiers of the merchant Visual Directory (ref. 1. 1-3 above).

Technology Architecture: Search is done dynamically by querying all available network affiliates. All matching merchants are collected, filtered thru EOS 10 rules, organized and then show to the user to guide their shopping needs.

### Merchant Coupon Application

Synopsis: Multi-step process for user to apply coupon codes visible in the merchant Visual Directory (and/or User-Specific coupons available thru the User-Specific Virtual Mall (ref. 1.1 and 1.1.1) to appropriate Checkout box on the merchant website.

User Experience: User clicks on merchant Enlarged Graphic Element or merchant Detail Page Element. User clicks on coupon code. User is automatically redirected to merchant URL. User shops at merchant site. When user enters the Checkout Cart, user clicks “Paste commands” and the code inserts into the appropriate box.

Technology Architecture: Coupon codes are aggregated from Affiliate databases, Company inputs, merchant inputs and User-Specific coupon database (ref. 1.1.1). Coupons routed through authentication process to verify validation. Coupon code is copied to the user's clipboard.

### Merchant Coupon Application Addendum A (Sort & Filter Capabilities)

Synopsis: Ability for user to sort and filter merchant coupons by pre-designates

### User Experience: User

### Technology:

### Merchant Coupon Application Addendum B

Synopsis: 1-Step Process for user to apply coupon codes visible in the merchant Visual Directory and/or user-specific coupons available thru the user-specific Virtual Mall (ref. 1.1 and 1.1.1). User clicks on the coupon and the coupon is automatically input into the appropriate Checkout box on the merchant site. No longer does user have to paste the code into place.

User Experience: User clicks on the Coupon Code (in both Virtual Mall and Visual Directory) in the Enlarged Graphic Element or merchant Detail Page. User is redirected to the merchant's website and told to shop. At Checkout, the user finds the coupon code already input into the appropriate Coupon/Promo Offer box. The user checks out and merchant applies coupon to order.

Technology Architecture: Company creates database of specific location of all Code/Promotional box locations on individual merchant sites. User clicks code. Server queries location of input box from database. Application input code data into appropriate Coupon Box in merchant web.

### Customizable, User-Specific Virtual Mall

Synopsis: Method and Web-Based Application for user of Company website to register, select, maintain and edit preference selections with a personalized, customizable Virtual Mall from which the user can shop online more efficiently, utilize additional user-specific methods, applications and processes, and enable user data gathering, tracking and analysis.

User Experience: The user registers and/or signs in to User-Specific Virtual Mall application. User populates Virtual Mall with user-specific selections of preferred merchants from the Comprehensive merchant Visual Directory, preferred coupons and/or offers, preferred notifications and/or various preferred option, filter and/or setting options. User can edit all user-specific preferences at will. Users can optimize search, sort, filter and highlight functions (ref. 1.0.1, 1.0.2) with the presentation of results within pre-established designates and/or within Virtual Mall user-specific preference filters and/or sorting methods. Users can alter and/or change settings of Virtual Mall to personalize Shopping Experience. Users can manipulate location of merchant elements (ref. 1.0) within Virtual Mall. Users can create own personal designates (“Custom Mall Floors”) for personalized visual display of merchant selections. Users can edit personal designates at will. Users can save all preferences, selections, designates, display choices, and settings. User can add preferences through various processes that relate to the Virtual Mall application. Company will gather, track, store and analyze user preference data to present user with services that better their shopping experience including recommendations of merchants for consideration, proffering unique user coupons (ref. 1.1.1) or offers, and providing targeted advertisements. Company will gather, track, store and analyze user preference data to present merchants and/or affiliates with targeted strategy suggestions and marketing opportunities that betters their service relationship with user.

### User-Specific Coupon Agent Application & Analysis

Synopsis: Method to analyze user behavior in user-specific Virtual Mall (ref 3 above), to solicit user-specific coupons from merchants and/or their affiliates, to encrypt user-specific coupons for exclusive use, to establish user-specific coupon redemption process with merchant, to monitor user-specific coupon redemption, to notify merchant and/or their affiliates of user-specific coupon redemption, to request and reissue user-specific coupon (upon merchant and/or affiliate approval), to repeat user-specific coupon process (as detailed above), and to consult merchant and/or their affiliates on user-specific coupon targeting opportunities and user-specific coupon behavior analysis.

User Experience: User accesses and interacts with user-specific Virtual Mall (ref 2). Company extracts data from user-specific Virtual Mall. Company provides encrypted, user-specific merchant coupon (based on user-specific activity and preferences) to user. User-specific coupon is made visible and accessible within Virtual Mall application to user. User is able to click on user-specific coupon and use for online shopping transactions at the designated merchant's website. User-specific coupon data is available as additional data feeds in search, sort, filter and/or highlight functionality within the user's Virtual Mall. User-specific coupons are trackable by Company, revocable at Company's discretion and non-transferable.

Technology Architecture: Request for user-specific coupon is based on User Data Analysis and/or User Market Opportunity Analysis. User Data Analysis and User Market Opportunity Analysis are determined by established rules applied to stored data of user behavior and/or preferences in their Virtual Mall. After analysis complete, Company exports user-specific request to merchant and/or its affiliate thru established request system. Merchant and/or affiliate response is stored in database. Company establishes user-specific coupon-specific database tracking of user activity. Upon approval, Company creates security-protected user-specific coupon code with User-Specific Coupon Code Creation process. User-specific coupon code is presented to user. When user-specific coupon is engaged by user, server initiates Verification Of Use process. If user-specific coupon passes Verification of Use process, Company analyzes user-specific data to determine whether to export new request to merchant and/or its affiliates thru established request system.

### User-Specific Coupon Application Addendum A

Synopsis: Process for user to apply coupon codes rate of discount directly to the merchant's product offerings on its website.

User Experience: User clicks on the Coupon Code (in both Virtual Mall and Visual Directory) in the Enlarged Graphic Element or merchant Detail Page. User is redirected to the merchant's website. User shops at merchant. Pricing for merchant

Technology: Browser plug-in installed on user's computer. When user clicks on User-Specific Coupon, browser plug-in reads merchant website data. Plug-in calculates discount price (based on coupon value) and “slashes” the price on merchant site to the new price (which incorporates the coupon discount).

### Wish List Storage & Retrieval

Synopsis: User application that enables user save product information and details from merchant site to User-Specific Virtual Mall Wish List File.

### Wish List Storage & Retrieval—(Product Search)

Synopsis: Ability for user to add a Product from Product Search to their Wish List (ref. 1.0.2)

User Experience: Registered user performs Product Search within User Virtual Mall and/or in Comprehensive merchant Visual Directory. User wants to save product result(s) from Search. User clicks on “Save to Wish List” button. User is prompted to register account with User-Specific Virtual Mall (if new), sign in with User-Specific Mall (if already registered), set up Wish List (if or Product detail & information is saved in Wish List.

### Notifications And Email Organization

User Experience: Set up email account with Company. Use Company-based email account for all shopping accounts
Automatic notification preferences for new coupons added (based on sorting and/or filtering); Automatic notification preferences for coupons about to expire (based on sorting and/or filtering); send users aggregate email notice.

Hierarchy
A new approach to the shopper process of shopping online that provides time and money savings by creating both innovations and efficiencies in merchant organization and display, product and merchant search, coupon and promotional offer tracking and usage, shipping and sales tracking, peer rating and review systems, product tracking, product pricing and user-specific coupon offers, pricing, merchant and product customizations.

Brokering User & Merchant for Saved Product (from Merchant Site)
Method and system for brokering a user-specific offer from a merchant to a user for purchase of an item sold via the merchant's site
   a. Enables user to capture detail and save detail for a product user wishes to purchase from merchant site in user account (“saved product”)
   b. Enables user to initiate and/or engage in brokering system for saved product
   c. Enables user to set preference on purchase price and/or discount, coupon or incentive (“user-specific offer”) on saved product
   d. Enables user to set preferences on elements of brokering system (which includes but is not limited to automation of offer and/or pricing acceptance, automation of offer and/or pricing rejection, frequency of bids, quantity of bids, time duration of bids, time duration of offer acceptance, offer perimeter preferences, pricing preferences, frequency of merchant notification, frequency of Company notification, delivery mechanism of merchant notification, delivery mechanism of Company notification, merchant preferences, detail specifications for similar products, pricing specifications for similar products)
   e. Enables Company to gather, sort, analyze and report user data (which includes user history, user account data, user behavior, user brokering preferences, user's saved product data), affiliate data and merchant data for goal of brokering purchase transaction (“brokering deal”) of saved product between user and merchant or merchant representative (“merchant”)
   f. Enables Company to contact merchant with report and/or proposal of user-specific offer for user's saved product
   g. Enables merchant to respond to Company report and/or proposal of user-specific offer for saved product
   h. Enables merchant to provide user with user-specific offer for saved product
   i. Enables Company to inform user of merchant user-specific offer for saved product
   j. Enables user to accept merchant's user-specific offer & complete purchase of saved product
   k. Enables user to save and/or defer merchant's user-specific offer for set period of time for saved product
   l. Enables user to decline merchant's user-specific offer for saved product
   m. Enables Company to track, store, filter, sort, and analyze all user data, user preferences, merchant data, merchant behavior, user behavior, brokering deal dada, and company data for use as brokering data (“user brokering data”)
   n. Enables Company to create, assign, aggregate and apply user group associations (“user groups”) to user for purpose of analysis, reporting and/or group brokering opportunities
   o. Enables Company to assign alias identification (“user alias”) to specific user in user brokering data reports to protect user identity and privacy
   p. Enables Company to track, store, filter, sort and report applicable specific-user brokering data to specific-user
   q. Enables user to sort, view and filter brokering deal data by time value, by date, by price value, by offer value, by product value (including A-Z, by brand, by price, by merchant, by rating), by similar product value (including by A-Z, by Brand, by price, by merchant, by rating), by user-assigned priority, by merchant detail (including A-Z, rating, inclusion in “Virtual Mall”)
   r. Enables Company to track, store, filter, sort and report general and/or specific-user brokering data to merchant using user alias
   s. Enables merchant to sort, view and filter brokering data reports by gender, by age, by specific user alias, by geography, by time, by date, by frequency, by IP address, and/or by user group.
   t. Enables user to re-initiate brokering of saved product (“user-initiated brokering”)
   u. Enables user to set limits, filters and/or sort preferences for merchant access to user's saved product(s) (e.g. User can choose to let all merchants, select merchants or no merchants access to their saved products)
   v. Enables Company to contact and/or inform merchants of user-initiated brokering of saved product
   w. Enables merchants to view, evaluate and respond to user-initiated brokering deal
   x. Enables merchants to accept and complete user-initiated brokering transaction with user
   y. Enables merchants to reject user-initiated brokering deal
   z. Enables user to enter into an agreement with merchant via Company to purchase saved product if stated terms of offers and/or pricing are agreed upon (“Agree to Buy”)—(e.g. User sets an “agree to buy” preference for an offer of $20 off and free shipping/free returns for a sweater; merchant agrees to those terms and user is obligated to complete the purchase)
   aa. Enables user to gather, save, and sort saved products before triggering the brokering system (e.g. user waits until they have three items from save merchant before Company requests an offer)

Brokering User & Merchant for Similar Product (from Merchant Site)
Brokering offer between user and merchant for an item that is similar to a saved item on the merchant's site
   bb. Enables user to set and/or assign definitions, preferences or parameters to definition of a product that is similar to user's saved product “similar product” (i.e. User captures and saves a product; user wishes to consider offers for products similar in value, quality and/or type to the saved product)
   cc. Enables user to enable (or disable) brokering system for similar product
   dd. Enables user to assign preferences and/or rules for user-specific offer for similar product
   ee. Enables all applications and processes for (as outlined in I)
   ff. Enables Company to gather, sort and analyze merchant and affiliate product data to identify similar product (“similar product data”)
   gg. Enables Company to apply user data (including user preferences, user account data, user brokering data), similar product data and merchant data to determine best brokering deal with similar products
   hh. Enables Company to contact merchant with report and/or proposal for user-specific offer for similar product(s)
   ii. Enables merchant to provide user with similar product detail and user-specific offer (within set time period)
   jj. Enables user to view similar product detail and corresponding user-specific offers
   kk. Enables acceptance, deferral and rejection applications of saved product (as outlined in I) to be applied to similar product brokering system
   ll. Enables user to save and store similar product detail and user-specific offer for a later time

Brokering User & Third-Party Merchant for Saved Product (from Merchant Site)
Brokering offer between user and other third-party merchant(s) for the same item that is sold at another merchant
   mm. Enables Company to initiate User-merchant Brokering, after set-time period, with merchant other than original merchant (“third-party merchants”) who sells the same saved product
   nn. Enables all relevant Brokering System processes and applications (as outlined in I-II)
   oo. Enables Company to track, sort and analyze merchant data, affiliate data and third-party product feed data for purpose of identifying merchants who sell the same saved product
   pp. Enables Company to contact, provide report and/or proposal to third-party merchant(s) for goal of brokering purchase transaction between user and saved product
   qq. Enables Company to apply the data used to initiate the brokering relationship between the user and merchant for the saved product with merchant data and Company data in order to broker a purchase transaction of similar product(s) between user and third-party merchant(s)
   rr. Enables multiple third-party merchants to view user's saved product(s), offer preferences, and pricing preferences without enabling merchant access to any user data, user account data, user history or user behavior data
   ss. Enable third-party merchants to initiate brokering offers with users
   tt. Enables user to view multiple third-party merchant offers for saved product

Brokering User & Third Merchant for Similar Product (from Merchant Site)
Brokering offer between user and other third-party merchant(s) for an item(s) that is similar to a product sold at a merchant site
   uu. Enables Company to contact third-party merchant(s) with report and/or proposal regarding potential similar product(s) and corresponding user-specific offers and/or pricing for those similar product(s)
   vv. Enables all applications outlined in I-V
   ww. Enables third-party merchants to provide user with product detail and user-specific offers for similar products
   xx. Enables user to view product detail and user-specific offers from multiple third-party merchants for similar product(s)

Brokering User & Merchant(s) for Saved Product (from Non-Merchant Site)
Brokering offer between user and merchant(s) for an item identified at a non-merchant site
   yy. Enables Brokering User & merchant for Saved Product processes and applications (as defined in I-IV) to be applied to saved item from a non-merchant site (including but not limited to blogs, editorial sites, news sites, recommendation sites, social media sites, group and/or sharing sites, personal sites)
   zz. Enables Company to define saved product by applying photo recognition processes, data analysis, web analysis, Company data, merchant data, affiliate data, and/or user data.
   aaa. Enables Company to target, identify, sort, filter and contact merchants which sell the saved product
   bbb. Enables Company to engage merchants in the Brokering Process as outlined in I-IV.

Brokering User & Merchant(s) for Similar Product (from Non-Merchant Site
Brokering offer between user and merchant(s) for an item defined as similar from an item identified at a non-merchant site
   ccc. Application of all processes outlined in II, IV, V as applied to similar product found at non-merchant site
   ddd. Enables company to filter, sort, define and engage merchants by company rules and/or user preferences

Brokering User & Merchant(s) for General Product from Wish List
Brokering offer between user and merchant(s) for a product listed in User's “Wish List”
   eee. Enables user to generate and store text-based general name, product name, general description or product description in user account (“wish list”)
   fff. Enables user to set preferences, descriptions and/or rules on wish list items
   ggg. Enables Company to track, organize and understand wish list using keyword data search and analysis, category data search and analysis and product feed search and analysis.
   hhh. Enables merchant to have access, recommendation and/or reports on user wish list for purpose of merchant providing user-specific offers and/or similar products
   iii. Enables merchant to provide user-specific offers and/or similar product detail for wish list
   jjj. Enables user ability to store, sort, filter and apply user-specific offers to wish list
   kkk. Applies all processes and applications outlined I-VI

Brokering User-Specific Offers (without Saved Product, Similar Product or Wish List)
lll. Enables Company to gather, store, analyze and report on user data (including user account data, user behavior and history, user preferences), merchant data, affiliate data, brokering data and Company data for purpose of recommending merchant to provide user-specific offers to users
mmm. Enables Company to provide recommendation and/or report to merchant
nnn. Enables merchant to respond to recommendation and/or report
ooo. Enables merchants to provide user with user-specific offers
ppp. Enables Company to store, protect and provide user-specific offer to user
qqq. Enables user to accept or decline user-specific offer
rrr. Enables user to save user-specific offer in same location as User-Specific Mall (reference: IX)
sss. Enables user to make purchases at merchant using user-specific offer
ttt. Enables Company to track, save, analyze and report on user usage of user-specific offer
uuu. Enables Company to
vvv. Enables automation process for re-issuing user-specific offers (based on merchant preference and rules)
www. Enables

Creation of User-Specific Mall
Provides ability to customize merchant selections, sorting, filtering and organization
   xxx. Enables user to select and store preferred merchant & details (URL link, offers, shipping and sale information, rating and reviews) in one location (“User Specific Mall”)
   yyy. Enables all user applications and processes (as referenced in I-X)
   zzz. Enables all user preferences, rules and settings (as outlined in I-X)
   aaaa. Enables all user saved product and similar product storage, retrieval, sort, filter and history (as outlined in I-X)
   bbbb. Enables user Wish List setting, inputs, tracking and storage
   cccc. Enables user to customize preferences for offer tracking and usage, notifications of merchant activity, notification of offer activity, product tracking, merchant tracking, merchant access
   dddd. Enables user to customize view of merchants
   eeee. Enables user to customize categorization of merchants
   ffff. Enables user to rate and review merchants
   gggg. Enables user to share rating and review data
   hhhh. Enables user to share coupon/offers
   iiii. Enables user to share preferred merchant filter/sort results
   jjjj. Enables user to track, sort and save coupon & offers
   kkkk. Enables user to set notification preferences for coupon & offers
   llll. Enables user to store, sort and apply User-Specific offers
   mmmm. Enables user to track, store and save product searches
   nnnn. Enables user to track, store and save merchant preferences
   oooo. Enables user to create profile, history and data for benefit of brokering user-specific offers and/or products between user and merchants
   pppp. Enables tracking, storage, aggregation, analysis and reporting of user data, user behavior data, user activity, user account data, user merchant preference, user brokerage data, Company data, affiliate data, and merchant data for maximizing shopping transactions within the merchant-user relationship as outlined in I-X.
   qqqq. Enables use of universal gift card application
   rrrr. Enables application and/or design of a fixed-price, priority shipping system for select merchants
   ssss. Enables tracking for incentive programs
   tttt. Enables merchant tracking and/or access to preferred user

Organization of Online Merchants by Mall Framework
Provides Visual Directory & ability to sort, filter, highlight and identify merchants by various category and search options
   uuuu. Enables users to sort, filter and view details on all online merchants from a central location
   vvvv. Enables users to view, sort, filter and identify merchants by various category, keyword, product searches
   wwww. Enables users to view, search, sort, filter and identify merchants by product search
   xxxx. Enables users to view, search, sort, filter and identify merchants by coupon and/or promotional offer search
   yyyy. Enables user to alternate, manipulate and customize views of merchants
   zzzz. Enables user to apply custom filter and/or sort preferences to merchant directory lists
   aaaaa. Enables Company to assign category, keyword, group or special identify associations to merchants
   bbbbb. Enables Company to create process for merchant validation, categorization
   ccccc. Enables Company to create filter and/or sort rules for merchants
   ddddd. Enables Company to present merchant filter and/or sort results to user
   eeeee. Enables user to apply additional filter and/or sort preferences to merchant search results
   fffff. Enables merchant to provide category, coupon/offer into direct data feed
   ggggg. Enables merchant to respond to user review
   hhhhh. Enables user to search for product within merchant directory
   iiiii. Enables user to sort, filter and organize product search results by preferences
   jjjjj. Enables peer rating and review system for merchants
   kkkkk. Enables social sharing of merchant detail (i.e. coupons, offers, shipping, rating, review, etc) between users and/or users and public
   lllll. Enables tracking, storage, aggregation and analysis of coupon/offer data, Company data, affiliate data, product data and merchant data for purpose of maximizing shopping transactions between users and merchants.
   mmmmm. Enables Company to set different color and style themes for merchant directory

1. A method of facilitating online shopping, comprising using an intermediate computer system for:
a) collecting data from online shopping interactions of each of a plurality of online shoppers;
b) obtaining additional online shopping preference information from one of said plurality of online shoppers related to a specific, potential online shopping transaction;
c) forwarding a request to one or more online merchants based on the preference information to modify terms and/or conditions of the potential online transaction; and
d) providing at least some of the related shopper's collected data for use by the one or more merchants considering the request,
whereby the transaction may be completed in accordance with said request upon agreement between the related shopper and said one or more merchants.

2. The method of claim 1 wherein a reply to the request is provided by the related merchant directly to the related shopper as part of the specific potential online shopping transaction to consummate that transaction upon acceptance by the related shopper.

3. The method of claim 1 further comprising:
receiving a response to the request from said one or more merchants; and
forwarding the response to the related shopper with a link enabling the related shopper to complete the potential online shopping transaction.

4. The method of claim 3 further comprising:
receiving and forwarding a plurality of responses to the request so that the related shopper may select a particular one of said plurality of responses.

5. The method of claim 1 wherein collecting data from online shopping interactions further comprises:
providing software plug-ins for download by each of a plurality of online shoppers so that data from online shopping interactions of said each of the plurality of online shoppers is automatically collected.

6. The method of claim 1 wherein collecting data from online shopping interactions further comprises:
receiving data from one or more merchants from online shopping interactions with one or more of the plurality of online shoppers.

7. The method of claim 1, further comprising:
providing access for each of the plurality of online shoppers to a website display of a virtual mall including a large plurality of merchants selectable by merchant icons.

8. The method of claim 7, further comprising:
modifying the virtual mall in accordance with user's merchant preferences.

9. The method of claim 7, further comprising:
displaying pending responses by modifying an appearance of a related merchant icon.

10. The method of claim 9, further comprising:
displaying pending requests by modifying an appearance of each related merchant icon.

11. The method of claim 7 further comprising:
displaying known promotion codes related to related merchant icons.

12. The method of claim 1 further comprising:
providing access to shoppers of available promotional codes.

13. The method of claim 1 wherein collecting data from online shopping interactions further comprises:
adding at least portions of the online shopping preference information, requests and/or merchant responses and resultant completed transactions; and
making at least portions of the collected data available for analysis without disclosing personal identities of the shoppers.
